(19) United States
(12) Patent Application Publication
(10) Pub. No.: US 2020/0043159 A1
(43) Pub. Date: Feb. 6, 2020

(54) ANALYSIS DEVICE, ANALYSIS METHOD, AND PROGRAM

(71) Applicant: NIKON CORPORATION, Tokyo (JP)

(72) Inventors: Hirotada WATANABE, Yokohama-shi (JP); Nobuhiko MAIYA, Yokohama-shi (JP); Shunsuke TAKEI, Yokohama-shi (JP); Takuro SAIGO, Tokyo (JP); Mamiko MASUTANI, Yokohama-shi (JP); Shinichi FURUTA, Yokohama-shi (JP); Masafumi YAMASHITA, Fujisawa-shi (JP); Shoko YAMASAKI, Tokyo (JP); Yosuke OTSUBO, Tokyo (JP)

(73) Assignee: NIKON CORPORATION, Tokyo (JP)

(21) Appl. No.: 16/338,618

(22) PCT Filed: Oct. 3, 2016
(86) PCT No.: PCT/JP2016/079327

§ 371 Date: Apr. 1, 2019

(51) Int. Cl. G06T 7/00; G06K 9/46; G01N 15/14

(52) U.S. Cl. CPC G06T 7/0012; G06K 9/46; G01N 2015/1006; G06T 2207/10056; G06T 2207/30024; G01N 15/1475

(57) ABSTRACT

An analysis device includes a living cell feature value extraction unit configured to extract a feature value of a living cell from a captured image of the living cell, a fixed cell feature value extraction unit configured to extract a feature value of a fixed cell from a captured image of a cell that is the fixed cell of the living cell, and a computing unit configured to associate a feature value of the living cell extracted by the living cell feature value extraction unit with a feature value of the fixed cell extracted by the fixed cell feature value extraction unit.

### TECHNICAL FIELD

Embodiments of the present invention relate to an analysis device, an analysis method, and a program.

### BACKGROUND ART

In biological science, medical science and the like, it is known that there is a correlation, for example, between a state of health, disease or the like and a state of cells, organelles inside the cells and the like. For that reason, for example, analyzing signaling pathways of information transmitted between cells or within cells can be helpful for research relating to biosensors in industrial applications, in the manufacture of drugs with the aim of preventing disease, and the like.

In various analysis techniques relating to cells and tissue slices, techniques are known that use image processing, for example (see Patent Document 1, for example).

### CITATION LIST

### Patent Literature

Patent Document 1: US 20140099014 A

### SUMMARY OF INVENTION

### Technical Problem

However, it is difficult to analyze correlation between both of the feature value of a cell in a living state and the feature value of the cell in a fixed state.

Having been conceived in light of the above-described problem, an object of the present invention is to provide an analysis device, an analysis method, and a program.

### Solution to Problem

An aspect of the present invention for solving the problem is an analysis device configured to analyze a correlation between feature values within a cell in response to a stimulus, the analysis device including a living cell feature value extraction unit configured to extract a feature value of a living cell from a captured image of the living cell, a fixed cell feature value extraction unit configured to extract a feature value of a fixed cell from a captured image of a cell that is the fixed cell of the living cell, and a computing unit configured to associate a feature value of the living cell extracted by the living cell feature value extraction unit with a feature value of the fixed cell extracted by the fixed cell feature value extraction unit.

### Advantageous Effects of Invention

According to an embodiment of the invention, it is possible to analyze a correlation between a feature value of a living cell and a feature value of a fixed cell corresponding to the living cell.

### BRIEF DESCRIPTION OF DRAWINGS

FIG. 1 is a schematic view illustrating one example of the configuration of a microscope observation system according to an embodiment.

FIG. 2 is a block diagram illustrating one example of the functional configurations of each of the units included in an analysis device according to an embodiment.

FIG. 3 is a flowchart illustrating one example of a computation procedure of a computing unit in the analysis device according to an embodiment.

FIG. 4 is a diagram illustrating an example of a cell image captured by the microscope observation system according to an embodiment.

FIG. 5 is a diagram illustrating an example of labels attached to a cell image captured by the microscope observation system according to an embodiment.

FIG. 6 is a diagram illustrating an example of matching between a labeled cell image and a cell time lapse image.

FIG. 7 is a diagram illustrating one example of a network of structures within a cell, output by the analysis device according to an embodiment.

FIG. 8 is a diagram illustrating one example of a network of structures within a cell, output by the analysis device according to an embodiment.

FIG. 9 is a diagram illustrating a relationship between a dynamic feature value such as a contraction period output by an analysis device and expression of a node such as a protein according to an embodiment.

FIG. 10 is a diagram illustrating a flow of a cell analysis example (part 1) executed by the microscope observation system according to an embodiment.

FIG. 11 is a diagram illustrating a flow of an analysis example (part 2) of a cell executed by the microscope observation system according to an embodiment.

FIG. 12 is a diagram illustrating one example of a network of structures within a cell, output by the analysis device according to an embodiment.

FIG. 13 is a diagram illustrating a flow of an analysis example (part 3) of a cell executed by the microscope observation system according to an embodiment.

FIG. 14 is a table illustrating an example of an intracellular component annotation database.

FIG. 15 is a table illustrating an example of a feature value annotation database.

### DESCRIPTION OF EMBODIMENTS

### First Embodiment

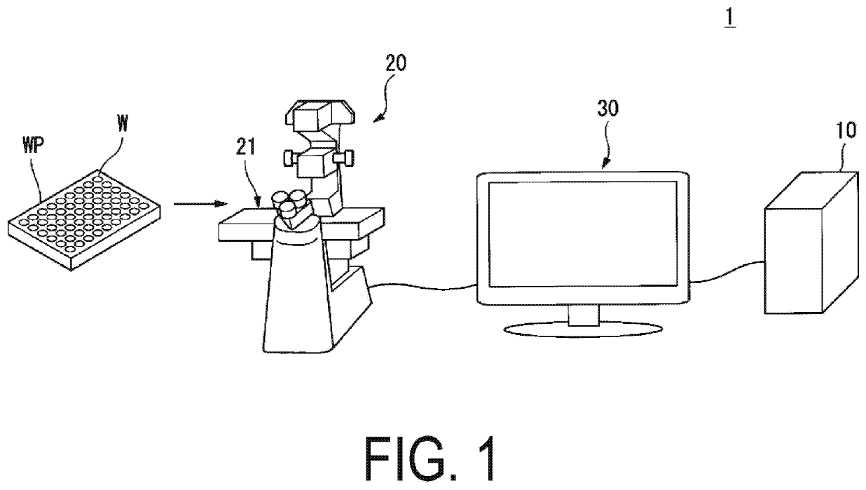

An embodiment of the present invention will be described below with reference to the drawings. FIG. 1 is a schematic diagram illustrating an example of a configuration of a microscope observation system 1 according to an embodiment of the present invention.

The microscope observation system 1 performs image processing on an image acquired by imaging a cell or the like. In the following description, an image acquired by imaging a cell or the like will also be simply described as a cell image.

The microscope observation system 1 includes an analysis device 10, a microscope device 20, and a display unit 30.

The microscope device 20 is a biological microscope and includes an electromotive stage 21 and an image capturing unit 22. The electromotive stage 21 can arbitrarily operate the position of the imaging object in a predetermined direction (for example, a certain direction within a two-dimensional plane in the horizontal direction).

The image capturing unit includes an imaging element such as a Charge-Coupled Device (CCD) or a Complementary MOS (CMOS) Photomultiplier Tube (PMT), and images the imaging target on the electromotive stage 21. Note that the microscope device 20 does not need to be provided with the electromotive stage 21, and the stage does not need to operate in a predetermined direction.

More specifically, the microscope device 20 has, for example, functions such as a differential interference contrast (DIC) microscope, a phase contrast microscope, a fluorescence microscope, a confocal microscope, a super-resolution microscope, a two-photon excitation fluorescence microscope, a light sheet microscope, and a light field microscope.

The microscope device 20 captures images of the culture vessel placed on the electromotive stage 21. The culture vessel includes, for example, a well plate WP and a slide chamber. The microscope device 20 irradiates cells cultivated inside a plurality of wells W provided in the well plate WP with light, and thus performs image capture of the transmitted light that is transmitted through the cells as the image of the cells. In this way, the microscope device 20 can obtain an image of the cells, such as a transmission DIC image, a phase contrast image, a dark field image, and a bright field image.

In addition, by irradiating the cells with excitation light that excites fluorescent material, the microscope device 20 captures an image of fluorescence emitted from the fluorescent material, as the image of the cells.

In the present embodiment, a cell is stained while the cell is still living, and time-lapse photographing is performed to acquire a change image of the cell after a stimulus is applied to the cell. In the present embodiment, a cell image is acquired by expressing a fluorescent fusion protein or staining with a chemical reagent or the like while keeping the cell alive. Yet in another embodiment, the cells are fixed and stained, and a cell image is acquired. Fixed cells stop metabolism. Therefore, when a stimulus is applied to a cell and the time-dependent changes in the cell are to be observed in the fixed cell, it is necessary to prepare a plurality of cell culture vessels seeded with the cells. For example, there are cases in which it is desired to apply a stimulus to a cell and observe changes after the first period of time, and observe the changes after the second period of time, which is different from the first period of time. In this case, a stimulus is applied to the cell and after the first period of time elapses the cell is fixed and stained, and a cell image is acquired.

Meanwhile, a culture vessel of a cell different from the cell used for the observation after the first period of time is prepared, and after the second period of time in which a stimulus is applied to the cell has elapsed, the cell is fixed and stained to obtain a cell image. In this manner, change with time in the cell can be estimated by observing the change of the cell after the first period of time and the change of the cell after the second period of time. The number of cell to be used for observing changes in the cell between the first period of time and the second period of time is not limited to one. Therefore, images of a plurality of cells will be acquired for each of the first period of time and the second period of time. For example, in the case where the number of cells for observing changes in the cell is 1000, a total of 2000 cells will be photographed for the first period of time and the second period of time. Therefore, when attempting to acquire a detail of changes in cells in response to a stimulus, a plurality of cell images will be required for each timing of capturing changes from a stimulus, resulting in acquiring a large amount of cell images.

Alternatively, the microscope device 20 may capture, as the image of the above-described cells, luminescence or fluorescence of the chromogenic substance itself taken into the biological material, or luminescence or fluorescence caused by the substance having a chromophore being combined with the biological material. In this way, the microscope observation system 1 can acquire a fluorescence image, a confocal image, a super-resolution image, or a two-photon excitation fluorescence microscopic image.

The method of acquiring an image of a cell is not limited to an optical microscope. For example, a method of obtaining an image of a cell may be an electron microscope. Further, images of cells obtained using different methods may be used to acquire correlations. That is, different types of images of a cell may be appropriately selected.

The cells of the present embodiment are, for example, primary cultured cells, subculture cells, tissue sections and the like. Observation of a cell may be performed by observing a sample which is a cell aggregate, a tissue sample, an organ, or an individual (of an animal and the like), or by acquiring an image containing a cell. Note that the state of a cell is not particularly limited to a specific state, and it may be in a living state or may be in a fixed state. The state of the cell may be “in-vitro”. It is naturally acceptable that the information in the living state and the information in the fixed state are combined.

Alternatively, a cell may be treated with chemiluminescence or fluorescent protein (for example, chemiluminescence or fluorescent protein expressed from the introduced gene (such as green fluorescent protein (GFP)) to be observed. Alternatively, the cells may be observed using immunostaining or staining with a chemical reagent. They may be combined to be observed. For example, it is also possible to select photoproteins to use according to the type of organelles (for example, Golgi apparatus) to be discriminated.

Further, pretreatment for acquiring correlation such as a means for observing these cells and a method for staining cells, and the like, may be appropriately selected according to the purpose. For example, in acquiring dynamic behavior of a cell by obtaining dynamic behavior of a cell using an optimal method for acquiring intracellular signal transduction, information on intracellular signal transduction may be acquired by using an optimal technique. A different method of preprocessing may be selected according to the purpose.

Further, types of preprocessing method to be selected according to the purpose may be reduced. For example, in a case in which the optimal method for acquiring dynamic behavior of a cell is different from the optimal method for acquiring intracellular signal transduction, as it can be cumbersome to acquire each information using respective methods, a common method other than the optimal method may be used if such method is sufficient for acquiring each information.

The well plate WP has one or more wells W. In this example, the well plate WP has 96 (8×12) wells. The number of well plates WP is not limited to this, and it may have 54 wells W (6×9) as described in FIG. 1. Cells are cultured in a well W under specific experimental conditions. The specific conditions include temperature, humidity, culture period, elapsed time from application of stimulus, kind and intensity of stimulus applied, concentration, quantity, presence or absence of stimulus, induction of biological features, and the like. The stimulus is, for example, a physical stimulus such as electricity, sound waves, magnetism, or light, or a chemical stimulus obtained by administering a substance, a drug or the like. In addition, the biological features are features that indicate a stage of differentiation of a cell, a form, a number of cells, behavior of molecules in a cell, form and behavior of organelles, each feature, behavior of intranuclear structure, behavior of DNA molecules, and the like.

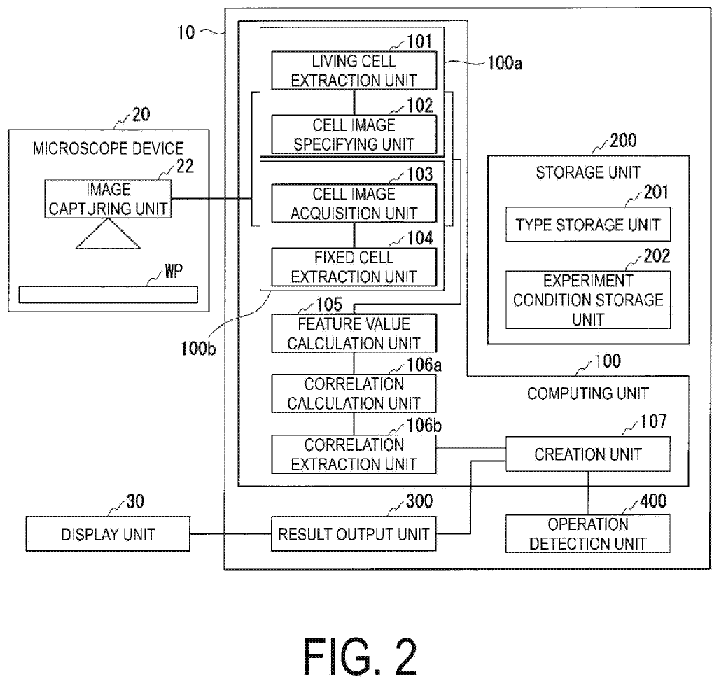

FIG. 2 is a block diagram illustrating an example of a functional configuration of each unit included in the analysis device 10 of the present embodiment. The analysis device 100 is a computer device that analyzes the image obtained by the microscope device 20.

The analysis device 10 includes a computing unit 100, a storage unit 200, a result output unit 300, and an operation detection unit 400.

The computing unit 100 functions from the processor executing a program stored in the storage unit 200. Further, out of each functional portion of the computing unit 100, some or all portions may be configured by hardware such as a Large Scale Integration (LSI), an Application Specific Integrated Circuit (ASIC), or General-Purpose Computing on Graphics Processing Units (GPGPU). The computing unit 100 includes a living cell extraction unit 101, a cell image specifying unit 102, a cell image acquisition unit 103, a fixed cell extraction unit 104, a feature value calculation unit 105, a correlation calculation unit 106a, a correlation extraction unit 106b, and a creation unit 107. The living cell feature value extraction unit 100a includes a living cell extraction unit 101 and a cell image specifying unit 102. Further, the fixed cell feature value extraction unit 100b includes a cell image acquisition unit 103 and a fixed cell extraction unit 104.

The living cell feature value extraction unit 100a extracts the feature value of the living cells. The living cell extraction unit 101 acquires the image of the living cell captured by the image capturing unit 22 and extracts the feature value of the living cell based on the acquired image of the living cell. For example, by observing each of a plurality of images captured at a predetermined time interval, the living cell extraction unit 101 may extract dynamic feature values such as contraction of the cell, heartbeat pulsation cycle, cell migration speed, change in the degree of aggregation of nuclear chromatin, which is an indicator of an energetic cell and a dying cell, changes in neurite number and its length, number of synapses, neural activity such as change in membrane potential, change in intracellular calcium concentration, degree of activity of second messenger, degree of change in organelle shape, behavior of molecule in the cell, form of the nuclear, behavior of the nuclear structure, behavior of DNA molecule, and the like. As the methods of extracting these feature values, for example, Fourier transform, wavelet transform, and temporal differentiation are used, and a moving average is used for noise removal. Hereinafter, observation by imaging at predetermined time intervals is referred to as “live observation”. The living cell extraction unit 101 supplies information indicating a cell such as position information of the cell from which feature values of a living cell have been extracted and the feature values of the living cell to the cell image specifying unit 102.

The cell image specifying unit 102 specifies a cell indicated by the information indicating the cell based on the information indicating the cell supplied by the living cell extraction unit 101. For example, the cell image specifying unit 102 attaches a label to the image of the cell by performing image processing on the cell indicated by the information indicating the cell. Further, the cell image specifying unit 102 classifies the images of the cells to which the label has been attached into a plurality of groups using the living cell feature value. Discrimination and identification techniques such as the clustering method are used, for example, as the method of classification. A local feature value based on the image processing may be used to track the movement of a cell. The cell image identifying unit 102 supplies image information of cells to which labels have been attached, included in each of the plurality of groups, to the fixed cell extraction unit 104.

The fixed cell feature value extraction unit 100b extracts the feature value of the fixed cell. Information for calculating the feature value of the fixed cell is provided to the feature value calculation unit 105. The cell image acquisition unit 103 acquires a fixed cell image captured by the image capturing unit 22 and supplies the obtained cell image to the fixed cell extraction unit 104. A living cell that has been fixed is used as the fixed cell. A living cell is applied a stimulus and after a predetermined offset time, fixed and stained before the cell image is acquired by the cell image acquisition unit 103. This causes images having different cell culture times to be included.

Also, in order to observe the cell, the cell may be pre-treated before observation. It is of course acceptable to observe the cell in a state with no pre-treatment. When observing a cell, a cell may be stained by immunostaining and observed.

For example, a stain solution may be selected for each element to discriminate (for example, Golgi apparatus) in the intranuclear structure within the cell. Any dyeing method can be used with regard to the dyeing method. For example, there are various special staining used mainly for tissue staining, hybridization using binding of nucleotide sequences, and the like.

The fixed cell extraction unit 104 acquires an image of a cell from the cell image specifying unit 102. The cell image specifying unit 102 attaches a label to the image of the living cell. The fixed cell extraction unit 104 specifies an image of a fixed cell corresponding to the cell to which the label is attached by the cell image specifying unit 102. The fixed cell extraction unit 104 extracts a cell image to which a label has been attached by the cell image specifying unit 102, out of a plurality of fixed cell images. The fixed cell extraction unit 104 then supplies the extracted cell image to the feature value calculation unit 105.

The feature value calculation unit 105 calculates a plurality of types of feature values based on the cell images supplied by the fixed cell extraction unit 104. This feature value includes the luminance of the cell image, the cell area in the image, the dispersion and shape of the luminance of the cell image in the image, and the like. Namely, the feature value is a feature derived from information acquired from the cell image to be captured. For example, the feature value calculation unit 105 calculates the brightness distribution in the acquired image.

The feature value calculation unit 105 associates the feature value extracted by the living cell extraction unit 101 with the feature value extracted by the feature value calculation unit 105, and sends them to the correlation calculation unit 106a. Namely, the feature value calculation unit 105 associates the living cell feature value extracted from the cell to which the label has been attached by the cell image specifying unit 102 with the feature value extracted by the feature value calculation unit 105. This makes associating the feature value of the living cell with the feature value of the fixed cell after extracting the feature value in the living cell possible.

The feature value calculation unit 105 calculates the feature value of the captured living cell and the feature value of the fixed cell after the lapse of the first time period from the application of the stimulus to the cell. Furthermore, the feature value calculation unit 105 calculates the feature value of the captured living cell and the feature value of the fixed cell after the second time period elapses from the application of the stimulus to the cell. In this manner, the feature value calculation unit 105 acquires images which are different in time series in response to a stimulus to the cell. In the present embodiment, a cell used for image capturing after the lapse of the first time period is different from a cell used for image capturing after the lapse of the second time period. It should be noted that the cell used for image capturing after the lapse of the first time period may be the same as the cell used for image capturing after the lapse of the second time period. The feature value calculation unit 105 calculates a change in feature value from the acquired image. The feature value calculation unit 105 may use the brightness distribution or position information of the brightness distribution as the feature value.

In the present embodiment, the feature value calculation unit 105 acquires images which are different in time series in response to a stimulus to calculate the change in a time series of the feature value, but the present invention is not limited to this. For example, the feature value calculation unit 105 may fix the time period after applying the stimulus and change the magnitude of the stimulus to apply, to calculate the change in the feature value due to the change in the magnitude of the stimulus.

Further, when no change is recognized from the cell image to be captured, it is acceptable to treat an absence of change as a change in the feature value.

The correlation calculation unit 106a calculates a correlation based on the feature value supplied from the feature value calculation unit 105. In the present embodiment, the correlation between the feature values is calculated from the feature value of the fixed cell obtained from the fixed cell image and the feature value of the living cell.

The correlation extraction unit 106b extracts a predetermined correlation from the correlation calculated by the correlation calculation unit 106a. A part of the correlation can be extracted by the correlation extraction unit 106b from the correlation calculated by the correlation calculation unit 106a.

The creation unit 107 creates a network image in accordance with the operation signal supplied by the operation detection unit 400 with respect to the specific correlation extracted by the correlation extraction unit 106b. For example, the creation unit 107 creates a network image representing the correlation between feature values. Elements of a network represented by the network image include a node, an edge, a subgraph (cluster), and a link. The characteristics of a network include presence/absence of a hub, presence/absence of a cluster, bottleneck, and the like. For example, whether a certain node has a hub can be determined based on the value of the partial correlation matrix. Here, the hub is a feature value having a relatively large number of correlations with other feature values.

When a hub exists in a certain node, it is conceivable that the feature value, which is the hub or the node including the hub, has a biologically important meaning. Therefore, the discovery of the presence of a hub can lead to a discovery of an important protein or an important feature value. Namely, use of the sparse inference result by the correlation calculation unit 106a can contribute to the discovery of an important protein or important feature value. The creation unit 107 outputs the created network image to the result output unit 300.

The result output unit 300 outputs the network image created by the creation unit 107 to the display unit 30. Note that the result output unit 300 may output the network image created by the creation unit 107 to an output device other than the display unit 30, or to a storage device, or the like.

The operation detection unit 400 detects an operation performed on the analysis device 10 and supplies an operation signal representing the operation to the creation unit 107.

The display unit 30 displays the network image output by the result output unit 300.

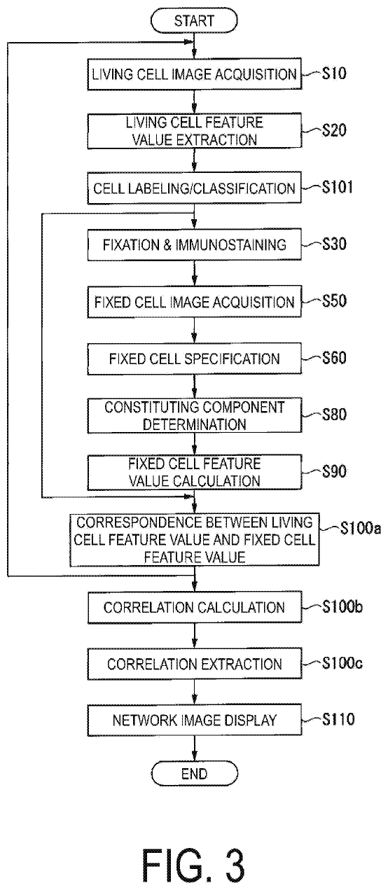

A specific computation procedure of the above-described computation unit 100 will be described with reference to FIG. 3.

FIG. 3 is a flowchart illustrating an example of a computation procedure of the computing unit 100 of the present embodiment. Note that the computation procedure illustrated here is merely an example, and a computation procedure may be omitted from or added to this computation procedure.

The computing unit 100 uses a cell image which is the captured image of the cell to extract a plurality of types of feature values of the cell image, and computes whether the changes of extracted feature values are correlated. Namely, the computing unit 100 calculates correlation with the other feature values. As a result of the calculation, when changes in the feature values are correlated, the computing unit 100 determines that there is a correlation. Note that a presence of a correlation between feature values may be referred to as a presence of a correlation.

The image capturing unit 22 acquires an image related to a living cell image (step S10). The computing unit 100 that acquires the image captured by the image capturing unit 22 extracts a region corresponding to a cell from the image. For example, the living cell extraction unit 101 extracts a contour from a cell image and extracts a region corresponding to the cell. Next, the living cell extraction unit 101 extracts a feature value concerning the living cell from the extracted cell area. It is possible to distinguish between a region corresponding to a cell and another region in the cell image, in this manner.

The living cell extraction unit 101 extracts the feature value of the living cell (step S20). This living cell contains a plurality of types of living tissues of different sizes, such as a gene, protein, organelle and the like.

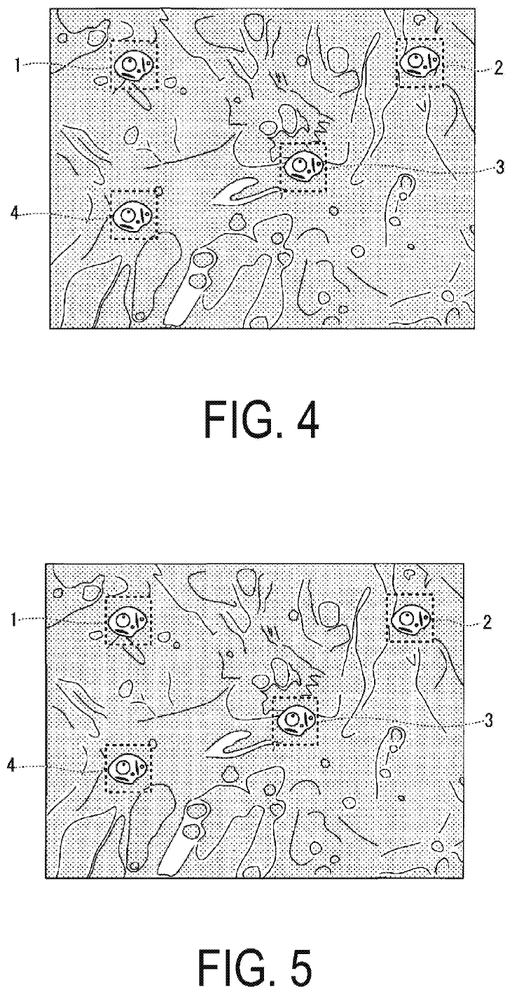

FIG. 4 illustrates an example of a living cell image captured by the image capturing unit 22. For example, the living-cell extraction unit 101 extracts the feature value of living cells such as the contraction of living cells from the image of the living cell captured by the image capturing unit 22. In the example illustrated in FIG. 4, the living cell extraction unit 101 extracts the feature value (1), the feature value (2), the feature value (3), and the feature value (4) from the image of the living cell. The living cell extraction unit 101 extracts living cells from an image including living cells. In the present embodiment, the feature value (1), the feature value (2), the feature value (3), and the feature value (4) are extracted from the place where feature values derived from living cells may be extracted.

The cell image specifying unit 102 attaches a label to the living cell image by performing an image processing on the living cell indicated by the information indicating the living cell, based on the information indicating the living cells supplied by the living cell extraction unit 101. Further, the cell image specifying unit 102 classifies the images of the living cells to which the label is attached into a plurality of groups (step S101).

FIG. 5 illustrates an example of a label to be attached to an image of a living cell captured by the image capturing unit 22. In the example illustrated in FIG. 5, the cell image specifying unit 102 attaches labels “1”, “2”, “3” and “4” respectively to each of the feature value (1), the feature value (2), the feature value (3) and the feature value (4) extracted in step S10. Further, the cell image specifying unit 102 classifies the feature values to which the labels are attached into a first group including the feature value “1” and the feature value “3” which are the fast contractions, and a second group including the feature value “2” and the feature value “4” which are the slow contractions. Note that, in this embodiment, living cells are extracted from images including living cells and labeled, but it is not necessary to attach labels. For example, if a dynamic feature value can be extracted without attaching a label to the image, labels do not have to be attached. Also, although the dynamic feature value has been calculated from the image, the dynamic feature value may be obtained by a method other than the method using an image. A method of obtaining a dynamic feature value from an image may be of course combined with a method other than the method using an image.

The living cell from which the living cell feature value is extracted in step S20 is fixed. A fixed living cell is stained by immunostaining (step S30).

The cell image acquisition unit 103 acquires an image of the fixed cell (step S50).

In addition, the image of the fixed cell contains cell shape information.

In the present embodiment, as an example, a description will be given of a case in which the cell image acquisition unit 103 acquires images (time lapse images) such that still images are joined to be displayed as a movie.

The fixed cell extraction unit 104 specifies images of cells to which labels have been attached, included in each of the plurality of groups, from the fixed cell images supplied from the cell image acquisition unit 103 (step S60).

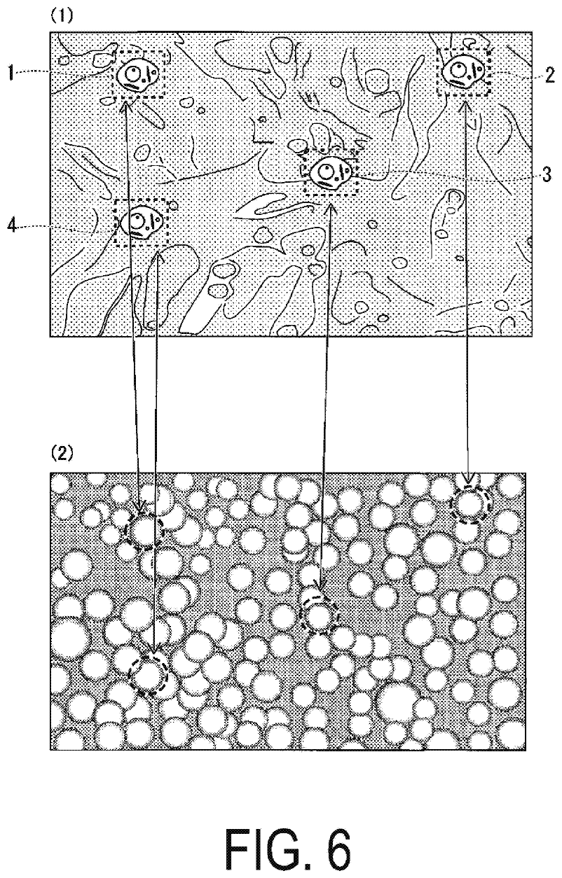

FIG. 6 illustrates an example of a process of specifying images of cells to which labels have been attached, from the image of fixed cells supplied from the cell image acquisition unit 103. FIG. 6(1) illustrates an image of the cells to which labels have been attached, and FIG. 6(2) illustrates the image of the fixed cells supplied from the cell image acquisition unit 103.

The fixed cell extraction unit 104 specifies the images of the cells to which the label “1”, the label “2”, the label “3” and the label “4” have been attached from the image of the fixed cells supplied from the cell image acquisition unit 103.

The feature value calculation unit 105 extracts the fixed cell image specified in step S50 (step S60). For example, the feature value calculation unit 105 extracts fixed cell images by applying image processing by a known method to fixed cell images. In this example, the feature value calculation unit 105 extracts fixed cell images by performing contour extraction of images, pattern matching, and the like.

Next, the feature value calculation unit 105 determines the components constituting the cells in the fixed cell region specified in step S60 (step S80). Here, the components of the cell include organelles such as a cell nucleus, lysosome, Golgi apparatus, and mitochondria, as well as protein, second messenger, mRNA, metabolite, and the like.

The present embodiment used cells of a single type, but when there are plurality of types of cells to be used, the type of the cell may be appropriately specified. For example, the type of the cell may be obtained from the contour information of the cell in the captured image. In addition, when the type of cells to be introduced is specified in advance, the type of the cell may be specified using that information. Of course, it is not necessary to specify the type of cells.

Next, the feature value calculation unit 105 calculates a feature value for each component of the cell determined in step S80 (step S90). This feature value includes the luminance value of the pixel, the area of a certain region in the image, the variance value of the luminance of the pixel, the shape of a certain region in the image, and the like.

In addition, there are a plurality of types of feature values corresponding to the components of cells. As an example, the feature value of the image of the cell nucleus includes the total intranuclear luminance value, the area of the nucleus, the shape of the nucleus, and the like.

Feature values of cytoplasmic images include total intracytoplasmic luminance value, cytoplasmic area, cytoplasmic form, and the like.

In addition, the feature value of the image of the whole cell includes the total intracellular luminance value, the area of the cell, the shape of the cell, and the like.

Further, the feature value of the image of mitochondria includes fragmentation rate and the like. Note that the feature value calculation unit 105 may calculate the feature value by normalizing it to a value between 0 (zero) and 1, for example.

Further, the feature value calculation unit 105 may calculate the feature value based on the information on the condition of the experiment with respect to the cell associated with the fixed cell image. For example, in the case of a cell image captured in the case where an antibody is reacted with respect to a cell, the feature value calculation unit 105 may calculate a feature value specific to the antibody.

In the case of a cell image captured when a cell is stained or when a fluorescent protein is imparted to a cell, the feature value calculation unit 105 may calculate the feature value specific to a case of staining the cell or fluorescent protein being imparted to the cell.

In these cases, the storage unit 200 may include the experiment condition storage unit 202. In the experiment condition storage unit 202, information on experiment conditions for cells associated with a cell image is stored for each cell image. The feature value calculation unit 105 associates the feature value extracted in step S20 with the feature value extracted in step S90 (step S100a). Namely, the feature value extracted from the cell to which the label is attached in step S20 is associated with the fixed cell feature value extracted in step S90.

Further, cells of different time periods with respect to the stimulus are created, and the operations from step S10 to step S90 are performed to associate the living cell feature value and the fixed cell feature value at different time periods with respect to the stimulus.

The living cell feature value and the fixed cell feature value of the different time-series with respect to the stimulus are supplied to the correlation calculation unit 106a. The correlation calculation unit 106a calculates a correlation between the living cell feature value and the fixed cell feature value (step S100b). Correlations to be calculated include a correlation between living cell feature values, a correlation between a living cell feature value and a fixed cell feature value, and a correlation between fixed cell feature values. The correlation extraction unit 106b extracts a part of the correlation out of the correlations calculated by the correlation calculation unit 106a (step S100c). The correlation calculation unit 106a extracts a specific correlation from the plurality of correlations between the feature values calculated by the feature value calculation unit 105 based on the likelihood of the feature value. For example, sparse inference is used as a method of extracting the correlation based on the likelihood of the feature value. The method of extracting the correlation is not limited to this, and the correlation may be extracted, for example, by the strength of correlation of the feature value.

Hereinafter, the processing performed by the correlation calculation unit 106a and the correlation extraction unit 106b will be described more specifically.

The correlation calculation unit 106a calculates a correlation from the living cell feature value and the fixed cell feature value. These feature values are calculated for each cell by the feature value calculation unit 105.

The calculation result of the feature value of a certain protein by the feature value calculation unit 105 will be described. The feature value calculation unit 105 calculates a plurality of feature values for each cell and for each time on the protein 1. The feature value calculation unit 105 calculates a feature value for N cells from the cell 1 to the cell N.

In addition, the feature value calculation unit 105 calculates a feature value for i pieces of time from the time T1 to the time T1 (i is an integer of 0<i). Further, the feature value calculation unit 105 calculates K kinds of feature values from the feature value k1 to the feature value kK (K is an integer of 0<K). Namely, the feature value calculation unit 105 calculates a plurality of feature values for each protein for each cell at each time.

Correlations between feature values are expressed by connecting types to be discriminated in structures inside cells by line segments. Hereinafter, a line segment connecting types to be discriminated in a structure in a cell is called an edge.

The correlation extraction unit 106b extracts biological information on feature values, out of the plurality of correlations between the feature values calculated by the correlation calculation unit 106a, from the intracellular component annotation database and the feature value annotation database, with respect to the feature value used for calculating the correlation. Then, the correlation extraction unit 106b extracts the biological interpretation indicated by the correlation based on the biological information of the extracted feature value.

An example of the specific correlation of the present embodiment will be described in detail. Hereinafter, structures within cells such as proteins and organelles are referred to as “nodes”. In addition, cellular organelles such as a cell nucleus, lysosome, Golgi apparatus, mitochondria and the like are referred to as “places”. A network of structures within a cell is expressed by connecting a plurality of nodes with edges.

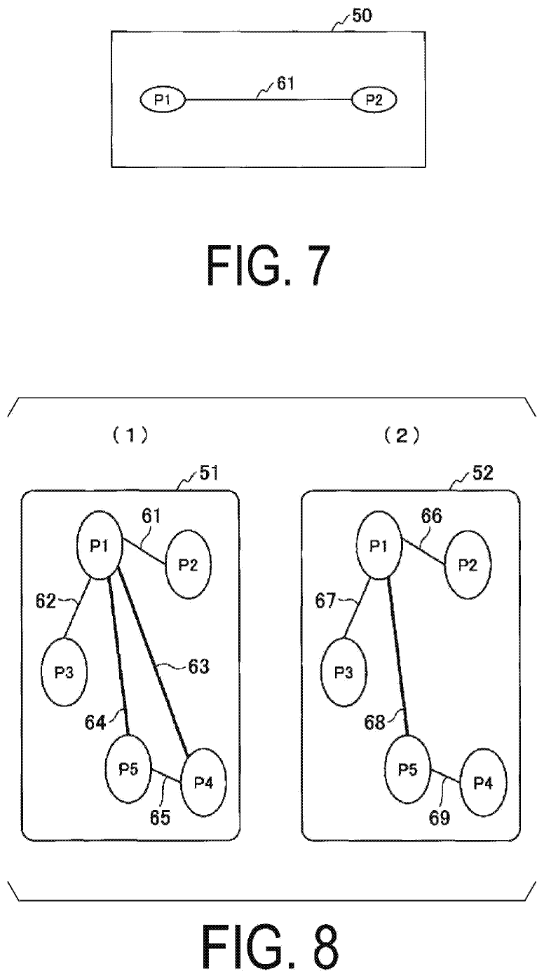

FIG. 7 illustrates an example of a network image of a structure in a cell. In the example illustrated in FIG. 7, at a location 50, the feature value of the node P1 and the feature value of the node P2 are bound by the edge 61.

The creation unit 107 creates a network image illustrating a specific correlation between the feature values extracted in steps S100b and S100c (step S110). Specifically, the creation unit 107 creates a network image according to the operation signal supplied by the operation detection unit 400. Further, when an operation to perform multi-scale analysis is performed on the analysis device 10, the creation unit 107 performs analysis and carries out processing of comparing feature values. Performing multi-scale analysis enables calculation of the correlation of the feature values in the cell after the stimulus is applied using the microscopic image. In this case, calculation of the correlation between the gene, the protein, the second messenger, the metabolite, and the phenotype from the microscopic image is enabled. For example, calculation of a correlation between a feature value of a protein and a feature value of a phenotype is enabled. As a result, calculation of the correlation between different elements of a plurality of scales is enabled. A phenotype is a feature value related to the shape of a cell, the death of a cell, the shape of an object in a cell, the number of objects in a cell, and the position of an object in a cell. Hereinafter, the processing performed by the creation unit 107 will be described in detail.

FIG. 8 illustrates an example of a network image of a structure in a cell. FIG. 8(1) illustrates a network image of a cell classified into the first group, and FIG. 8(2) illustrates a network image of a cell classified into the second group.

The network image illustrated in FIG. 8(1) indicates that the node P1, the node P2, the node P3, the node P4, and the node P5 are present in a location 51. Further, the node P1 and the node P2 are connected by an edge 61, the node P1 and the node P3 are connected by an edge 62, the node P1 and the node P4 are connected by an edge 63, the node P1 and the node P5 are connected by an edge 64, and the node P4 and the node P5 are connected by an edge 65.

The network image illustrated in FIG. 8(2) indicates that the node P1, the node P2, the node P3, the node P4, and the node P5 are present in a location 52.

Further, the node P1 and the node P2 are connected by an edge 66, the node P1 and the node P3 are connected by an edge 67, the node P1 and the node P5 are connected by an edge 68, and the node P4 and the node P5 are connected by an edge 69.

According to FIG. 8(1) and FIG. 8(2), edges connecting the node P1 and the node P4 exist in the network image of the cell classified into the first group, does not exist in the network image of the cell classified into the second group. This illustrates that the difference in the cycle of contraction of cells is due to the difference in topology between the networks of cells.

When an operation to perform multi-scale analysis is to be performed on the analysis device 10, the creation unit 107 performs analysis and carries out processing of comparing feature values. The computing unit 100 performs multi-scale analysis based on the dynamic feature value of the living cells and the feature value of the fixed cells.

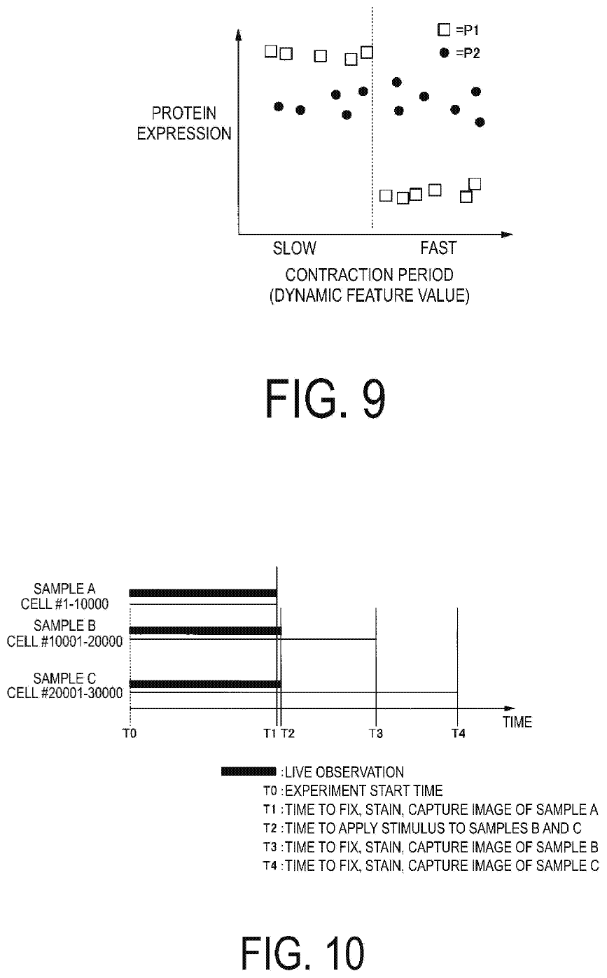

FIG. 9 illustrates the relationship between dynamic feature values such as contraction cycle of living cells and expression of nodes such as proteins. In this case, the contraction cycle is extracted as the feature value of the living cells, the expression of the proteins P1 and P2 is extracted as the feature of the fixed cells, and both are compared. It is known that the contraction period of cells depends on the maturity and type of cells (atrium, ventricle, pacemaker, and the like).

For example, in a case where the network image of FIG. 8 is displayed on the display unit 30, when the operation of comparing the feature values is performed on the analysis device 10, the creation unit 107 analyzes a relationship between the dynamic feature value such as a contraction period and the expression of nodes such as proteins, and the characteristics illustrated in FIG. 9 are displayed. According to FIG. 9, the expression of the node P1 varies between the case in which the contraction period is slow and the case in which the contraction period is fast, and the expression of the node P2 changes little irrespective of the contraction period compared to the node P1.

In addition, a normal cell and a cancer cell are prepared as cells to be used for analysis, and the analysis device 10 calculates the correlation respectively. The analysis device 10 may compare differences in mechanisms to respond to stimulus between a normal cell and a cancer cell by extracting specific correlations and comparing the extracted correlations between a normal cell and a cancer cell. In this manner, the analysis device 10 is capable of performing a multi-scale analysis which is one step more detailed than using a network image. In the present embodiment, in addition to enabling the structure of the protein in the cell to be specified and the corresponding feature values to be analyzed, the analysis device 10 has enabled the feature values such as the dynamic characteristic of the cell to be analyzed, which has a vastly different scale compared with a protein. In addition, the analysis device 10 could extract dynamic feature values such as the pulsation period of cells, and extract static feature values such as the localization of the intracellular protein of the cell from which the dynamic feature value has been extracted, enabling calculation of the correlation between these feature values. The analysis device 10 was able to analyze the correlation between the dynamic feature value and the static feature value, which are the different characteristics of the cell. In addition, in the present embodiment, the analysis device 10 was able to analyze the changes in feature values that change over time, not just the feature values at a given timing, by analyzing feature values having different elapsed time periods after a stimulus was applied. In addition, in the present embodiment, the analysis device 10 could analyze the changes in the feature values with different magnitude of the stimuli, thereby enabling an analysis of changes in feature values due to the varying magnitude of stimuli.

### Multi-Scale Analysis Example (Part 1)

An example of cell analysis (part 1) by the microscope observation system 1 according to this embodiment will be described.

FIG. 10 is a diagram illustrating a flow of a cell analysis example (part 1). In FIG. 10, T0 indicates the time to start the experiment. In FIG. 10, T1 indicates a time at which the sample A is fixed, dyed, and an image is captured. In FIG. 10, T2 indicates the time at which the stimulus is applied to the sample B and the sample C. In FIG. 10, T3 and T4 respectively illustrate the time at which the sample B is fixed, stained, and an image is captured, and the time at which the sample C is fixed, stained, and an image is captured.

In the example of cell analysis (part 1), a sample A including cells #1-10000, a sample B including cells #10001 to 20000, and cells #20001 to 30000 are prepared. In this example, a live observation of sample A, sample B, and sample C is performed from time T0 to time T1.

Between time T0 and time T1, the living cell extraction unit 101 extracts a dynamic feature value from the cell image. For example, the living cell extraction unit 101 may extract a contraction period as a dynamic feature value from living cells.

At time T2, the sample A is stained by immunostaining and a cell image is captured.

At time T2, a stimulus is applied to sample B and sample C. The stimulus is, for example, a physical stimulus such as electricity, sound waves, magnetism, or light, chemical stimulus by administering a substance drug, and the like, or a stimulus by a physiologically active substance such as peptide, protein, antibody or hormone.

Sample B is fixed, stained by immunostaining, and a cell image is captured at time T3. Sample C is fixed, stained by immunostaining, and a cell image is captured at time T4.

A network image similar to the image illustrated in FIG. 8 was obtained as a result of separately capturing the images of the cell with a short contraction period and the cell with a long contraction period under the conditions indicated in FIG. 10. Correlation between the nodes of a cell with short contraction period and correlation between the nodes of a cell with long contraction period can be compared in a network image as illustrated in FIG. 8.

### Multi-Scale Analysis Example (Part 2)

An example of cell analysis (part 2) by the microscope observation system 1 according to this embodiment will be described. In this analysis example, dynamic features are acquired during the period from the application of the stimulus to the living cells to the fixation, and treated as the feature value for the multi-scale analysis.

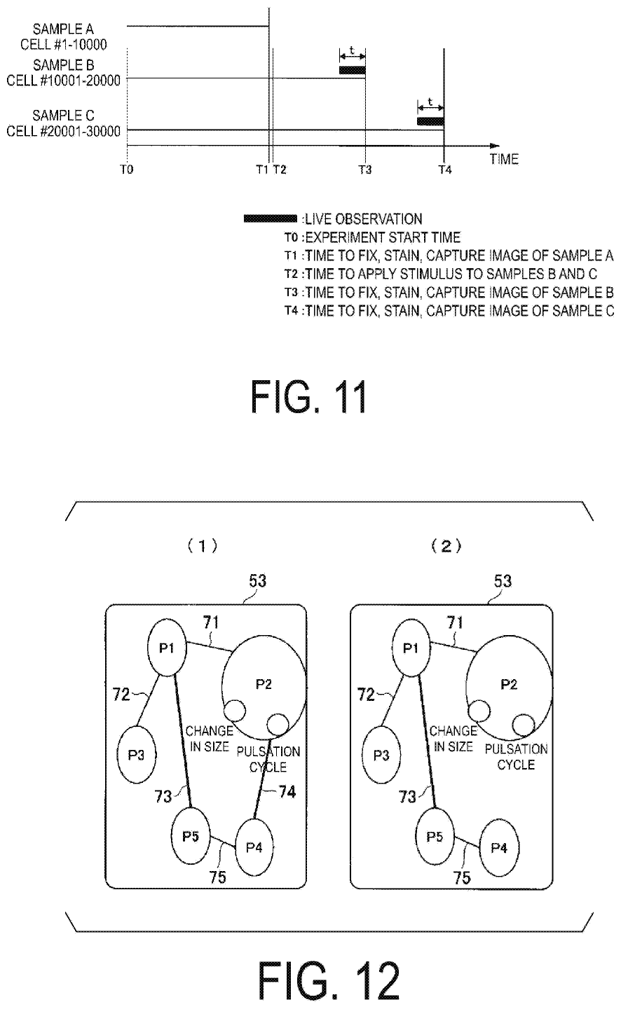

FIG. 11 is a diagram illustrating a flow of a cell analysis example (part 2). In FIG. 11, T0 indicates the time to start the experiment, and T1 indicates a time at which the sample A is fixed, dyed, and an image is captured. T2 indicates the time at which the stimulus is applied to the sample B and the sample C. T3 and T4 respectively illustrate the time at which the sample B is fixed, stained, and an image is captured, and the time at which the sample C is fixed, stained, and an image is captured.

In the example of cell analysis (part 2), a sample A including cells #1-10000, a sample B including cells #10001-20000, and a sample C including cells #20001-30000 are prepared. In this example, the living cell extraction unit 101 extracts dynamic feature values from the cell image during the time t before fixation. For example, the living cell extraction unit 101 may extract a contraction period as a dynamic feature value from living cells. Then, based on the information indicating the cells supplied by the living cell extraction unit 101, the cell image specifying unit 102 specifies the cells indicated by the information indicating the cells. For example, the cell image specifying unit 102 specifies cells having a contraction period are shorter than the threshold value and cells having a contraction period are longer than the threshold value.

At time T1, a stimulus is applied to sample B and sample C. The stimulus is, for example, a physical stimulus such as electricity, sound waves, magnetism, or light, chemical stimulus by administering a substance drug, and the like, or a stimulus by a physiologically active substance such as peptide, protein, antibody or hormone.

Sample A is fixed, stained by immunostaining, and a cell image is captured at time T1. No stimulus is applied to sample A. Further, in the present embodiment, a live observation has not been performed before time T1. Note that a live observation may be performed before time T1. For sample B, a live observation is started before time T3 elapses, and before time T3 by a period of time t. Then, the sample A is fixed, stained by immunostaining, and a cell image is captured at time T3. Namely, a live observation is performed while a cell is living after a stimulus has been applied.

For sample C, a live observation is started before time T4 elapses, and before time T4 by a period of time t. Then, the sample B is fixed, stained by immunostaining, and a cell image is captured at time T4 which is a time after a lapse of time from time T3. Namely, a live observation is performed while a cell is living after a stimulus has been applied.

As a result of capturing image of the cells under the conditions indicated in FIG. 11, the network image illustrated in FIG. 12 is obtained.

The network image illustrated in FIG. 12(1) indicates that the node P1, the node P2, the node P3, the node P4, and the node P5 are present in a location 53. Further, the node P1 and the node P2 are connected by an edge 71, the node P1 and the node P3 are connected by an edge 72, the node P1 and the node P5 are connected by an edge 73, the node P2 and the node P4 are connected by an edge 74, and the node P4 and the node P5 are connected by an edge 75.

The network image illustrated in FIG. 12(2) indicates that the node P1, the node P2, the node P3, the node P4, and the node P5 are present in the location 53. Further, the node P1 and the node P2 are connected by an edge 71, the node P1 and the node P3 are connected by an edge 72, the node P1 and the node P5 are connected by an edge 73, the node P2 and the node P4 are connected by an edge 74, and the node P4 and the node P5 are connected by an edge 75. Here, the pulsation period of the node P2 correlates with the feature value of the node P4. Thus, when analysis of what kind of signal is transmitted by the stimulus is performed, it can be seen that pulsation is included in one of the feature values.

According to FIG. 12(1) and FIG. 12(2), the edge connecting node P2 and node P4 exists in FIG. 12(1) and does not exist in FIG. 12(2). Thus, when analysis of what kind of signal is transmitted by the stimulus is performed, it can be seen that a pulsation cycle is included in one of the feature values.

### Multi-Scale Analysis Example (Part 3)

An example of cell analysis (part 3) by the microscope observation system 1 according to this embodiment will be described.

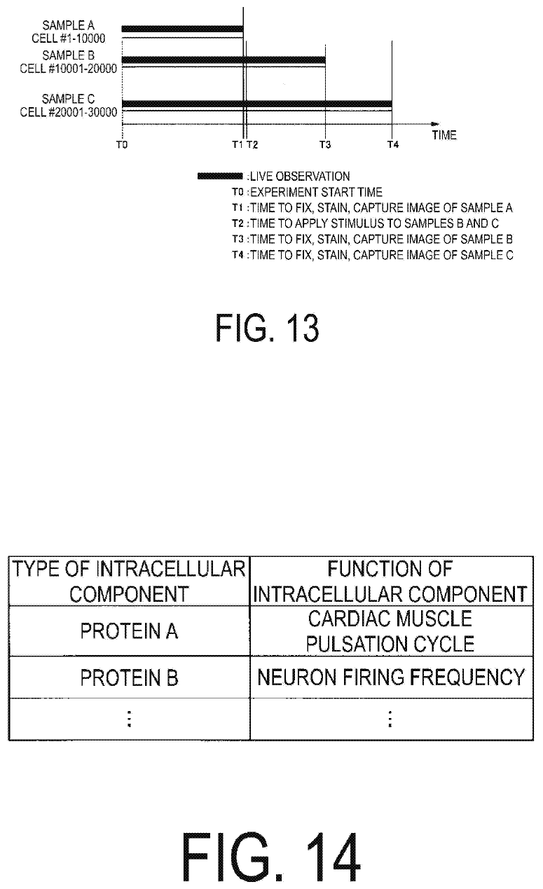

FIG. 13 is a diagram illustrating a flow of a cell analysis example (part 3). In FIG. 13, T0 indicates the time to start the experiment, and T1 indicates a time at which the sample A is fixed, dyed, and an image is captured. T2 indicates the time at which the stimulus is applied to the sample B and the sample C. T3 and T4 respectively illustrate the time at which the sample B is fixed, stained, and an image is captured, and the time at which the sample C is fixed, stained, and an image is captured.

In the example of cell analysis (part 3), a sample A including cells #1-10000, a sample B including cells #10001-20000, and a sample C including cells #10001-20000 are prepared. In this example, the living cell extraction unit 101 extracts dynamic feature values from the cell image during the time T0 when the experiment is started to time T4.

For example, the living cell extraction unit 101 may extract a contraction period as a dynamic feature value from living cells. Then, based on the information indicating the cells supplied by the living cell extraction unit 101, the cell image specifying unit 102 specifies the cells indicated by the information indicating the cells. For example, the cell image specifying unit 102 specifies cells having a short contraction period and cells having a long contraction period.

At time T2, a stimulus is applied to the sample B and the sample C.

In the sample A, a live observation is performed from time T0 to time T1.

In the sample B, a live observation is performed from time T0 to time T3. Then, the sample B is fixed at time T3, stained by immunostaining, and a cell image is captured. In other words, a live observation is performed before adding the stimulus and while the cell is alive.

In the sample C, a live observation is performed from time T0 to time T4. Then, the sample C is fixed at time T4, stained by immunostaining, and a cell image is captured. In other words, a live observation is performed before adding the stimulus and while the cell is alive.

In the above-described embodiment, a case is described in which a label is attached to an image of a cell, and an image of a cell to which a label is attached is classified into a plurality of groups to be output, but the present invention is not limited to this example. For example, a label may be attached to an image of a cell and output without being classified into groups.

Further, in the above-described embodiment, the feature value of the living cell is extracted based on the image of the living cell, and based on the information indicating the cell from which the feature value of the living cell is extracted, the cell is indicated by the information indicating the cell, but the present invention is not limited to this example. For example, a feature value of a living cell may be extracted based on an image of a living cell, and a cell corresponding to the feature value of the living cell may be extracted from the image of the cell which is the fixed cell of the living cell.

Note that, in the above embodiment, it is desirable that the time from T0, which is the time when the experiment is started, to T1, and the time from T0 to T2, are the same time. Note that, since the sample A is for a reference experiment without a stimulus being applied, as opposed to the sample B and the sample C observed being applied a stimulus, the time from T0 to T1 may be different from the time from T0 to T2.

As described above, in the microscope observation system 1 according to the present embodiment, a live observation and a multi-scale analysis can be combined. For this reason, a multi-scale analysis can be performed on the cells specified by the live observation after they are fixed and stained, enabling measurement of many behaviors of the cells. Specifically, behavior of various proteins can be measured by staining proteins with antibodies after the fixation. Namely, the dynamic feature values of protein and the feature values of various kinds of proteins can be measured.

If the dynamic features and the protein characteristics are to be captured entirely through a live observation, a fluorescent image of Green Fluorescent Protein (GFP) and the like will be used to observe migration speed of mitochondria, behavior of protein such as localized change for cell division (M phase, S phase), behavior of second messenger, changes in gene expression, and the like. On the other hand, in the present embodiment, observation of the dynamic feature value was performed live, and the feature value measurement of various kinds of proteins was performed after the proteins were fixed and stained. Accordingly, in the present embodiment, the influence on the quantitativity of the protein due to the influence of the fluorescent protein over the observed protein can be suppressed.

In addition, in order to capture the characteristics of proteins through a live observation, it is difficult to produce a number of stably expressing cells corresponding to combinations of proteins. It is difficult to measure feature values of many kinds of proteins. For example, it may be even difficult to create cell 1 (protein A: GFP, protein B: RFP), cell 2 (protein A: GFP, protein C: RFP), and cell 3 (protein B: GFP, protein C: RFP).

Further, according to the analysis device 10, the feature value was acquired in order to acquire the correlation of the feature value from the image of the living cell. Information other than brightness information and the like directly derived from the image can also be used as the feature value. For example, the analysis device 10 may extract the cell shape in the image, out of the luminance information directly obtainable from the image, compare the shape with the shape information in the database, and specify the cell type based on the similarity of the shape. Further, the analysis device 10 may extract the shape of the elements constituting the cell, out of the luminance information directly obtainable from the image, compare the shape with the shape information in the database, and specify the elements constituting the cell based on the similarity of the shape. For example, the elements constituting the cell are the nucleus of the cell, the nuclear membrane, and the cytoplasm. Further, according to the analysis device 10, there are cases where it is known that, as a feature of the introduced stain solution, selective interaction occurs only at a predetermined part as the staining is performed. In this case, when a staining position can be specified from the image, presence of the predetermined part at the staining position can be specified.

In this manner, the correlation of the feature values can be acquired using the information estimated from the image information, in addition to the information directly derived from the image information.

Further, for example, in the case of acquiring the intracellular correlation, when acquiring intracellular correlation, for example, there are cases where a plurality of cells can be obtained in a living cell image, and in the plurality of living cells, it is possible to acquire intracellular correlation. In this case, when acquiring the correlation in a plurality of living cells, since it is possible to acquire the correlation in a plurality of living cells as compared with the case where correlation of a single living cell is acquired, the accuracy of the signaling path for example calculated as acquisition of correlation can be increased.

In addition, the feature value calculated by the feature value calculation unit 105 may be calculated by extracting as the feature value, for example, in a case in which signal transmission in the cell after the cell receives a signal from the outside is to be included in a correlation, the behavior of the protein involved in the signal transmission in the cell and the accompanying changes of the cell.

Namely, for example, it may be a type of a substance involved in intracellular signal transduction, or may be a resultant change in shape of a cell from a signal transmission within a cell. Specification of a substance involved in intracellular signal transduction may be specified by Nuclear Magnetic Resonance (NMR) or the like, or performed by a method of analogizing the interaction partner from the staining solution.

### Second Embodiment

The microscope observation system 1 according to the first embodiment can be applied to the microscope observation system according to the present embodiment of the invention. The microscope observation system according to the present embodiment is adapted to obtain a biological interpretation from a network of structures inside a cell.

The microscope observation system according to the present embodiment stores the intracellular component annotation database and the feature value annotation database described later in the storage unit 200.

The correlation extracting unit 106b extracts biological information on feature values, out of the plurality of correlations between the feature values calculated by the correlation calculation unit 106a, from the intracellular component annotation database and the feature value annotation database, with respect to the feature value used for calculating the correlation. Then, the correlation extraction unit 106b extracts the biological interpretation indicated by the correlation based on the biological information of the extracted feature value.

FIG. 14 is a table illustrating an example of an intracellular component annotation database. This intracellular component annotation database associates the type of intracellular component with the function of intracellular component. In the present embodiment, the functions of the intracellular components include dynamic features. In the microscope observation system according to this embodiment, the intracellular component annotation database is stored in the storage unit 200 in advance.

Specifically, in the intracellular component annotation database, the type “intracellular component” “protein A” is associated with the function “intracellular component function” “cardiac muscle pulsation cycle”. This means that protein A promotes the cardiac muscle pulsation cycle. Also, in the intracellular component annotation database, the type “intracellular component” “protein B” is associated with the function “intracellular component function” “neuron firing frequency”. This means that protein B promotes neuron firing frequency.

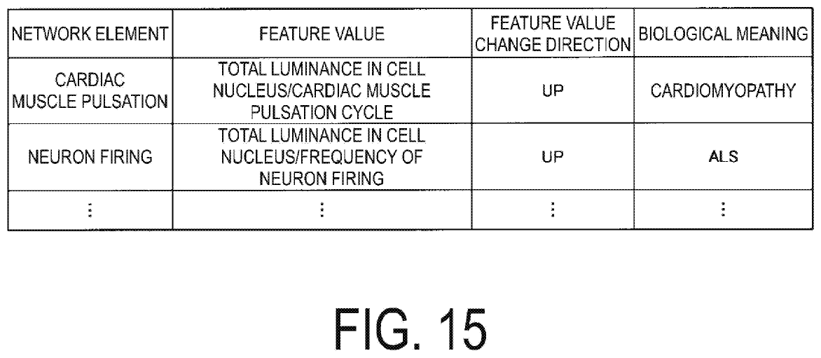

FIG. 15 is a table illustrating an example of a feature value annotation database. This feature value annotation database associates, between each other, a network element, a feature value, a change direction of a feature value, and information indicating a biological meaning. Here, the feature value includes a feature value of a dynamic feature. In the microscope observation system according to the present embodiment, the feature value annotation database is stored in advance in the type storage unit 201 of the storage unit 200.

Specifically, in the feature value annotation database, the network element “cardiac muscle pulsation cycle”, the feature value “total luminance value in the cell nucleus/cardiac muscle pulsation cycle”, the feature value change direction “UP”, and the biological meaning “cardiomyopathy” are associated with each other. This means that the feature values “total luminance in the cell nucleus” and “cardiac muscle pulsation cycle” associated with the network element “cardiac muscle pulsation cycle” signify that the cell is cardiomyopathy if both values go up together. Further, in the feature value annotation database, the network element “neuron firing frequency”, the feature value “total luminance in the cell nucleus/neuron firing frequency”, the feature value change direction “UP”, and the biological meaning “ALS”, are associated with each other. Here, ALS is amyotrophic lateral sclerosis.

This means that when the feature value “total luminance in the cell nucleus” and “neuron firing frequency” associated with the network element “neuron firing frequency” both increase, it is a cell of ALS.

The feature value annotation database can be created by using a cell of ALS symptoms and measuring the relationship between the cardiac muscle cell and the nuclear total luminance of the cell nucleus from the cell observation of the ALS symptom.

In the case where the correlation to be extracted, namely, the correlation between the increase in the total luminance value in the cell nucleus of the image of the protein A and the shorter cycle of the cardiac muscle cell pulsation cycle is high, the correlation extraction unit 106b performs a following biological interpretation.

The correlation extraction unit 106b determines based on the intracellular component annotation database that the function of the protein A is related to the “cardiac muscle pulsation cycle”. Then, based on the feature value annotation database, the correlation extraction unit 106b determines that the biological meaning is “cardiomyopathy” if the feature value “total luminance in the cell nucleus/cardiac muscle pulsation cycle” associated with the “cardiac muscle pulsation cycle” indicates a feature change “UP”. Namely, the correlation extraction unit 106b is enabled to estimate the symptoms of the cell from the cell image based on the intracellular component annotation database and the feature value annotation database.

As another example, the correlation extraction unit 106b determines that the function of the protein B is related to the “neuron firing” based on the intracellular component annotation database. Next, based on the feature value annotation database, when the feature value “total luminance in the cell nucleus/neuron firing frequency” associated with “neuron firing frequency” indicates a feature change “UP”, the correlation extraction unit 106b determines that the biological meaning is “ALS”.

Based on these determination results, the correlation extraction unit 106b may add the following biological interpretation of the correlation. Specifically, the correlation extraction unit 106b adds the biological interpretation of the correlation, such as, (1) that from the correlation between the pulsation cycle of the cardiac muscle cell and the protein A, it is a symptom of cardiomyopathy, (2) that from the correlation between the neuron firing and protein B, it is ALS. The microscope observation system according to the present embodiment, is capable of providing suggestions on the mechanism of diseases.

As described above, the microscope observation system according to the present embodiment, is capable of providing suggestions on the biological interpretation of the correlation based on the extraction result of the correlation between the feature values of the cells and the biological information. The microscope observation system creates biological information of the feature value from the feature value of the cell used for acquiring the correlation. Then, the microscope observation system adds the dynamic feature value of the cell. Namely, the microscope observation system creates biological information on the feature value of the cell used for acquiring the correlation. As a result, the microscope observation system is capable of performing the biological interpretation of the extracted correlation.

Note that, a dynamic feature may be, besides a heartbeat pulsation period and a neuron firing frequency, a change in a membrane potential of a nerve cell, or a change in a length of a spine of a nerve cell. Also, a biological interpretation may be, in addition to cardiomyopathy and ALS, Parkinson's disease, depression or cerebrovascular disorder.

Note that the above-described various processing steps may be realized by recording a program for executing these processing steps of the analysis device 10 in a recording medium that can be read by a computer and causing a computer system to read and execute the program recorded in the recoding medium.

Note that the “computer system” referred to here includes an OS and hardware such as a peripheral device. Further, when the “computer system” uses a WWW system, this includes a homepage provision environment (or display environment). Moreover, a “recording medium that can be read by a computer” refers to a portable recording medium such as a flexible disk, a magneto-optical disk, a ROM, a writable non-volatile memory such as a flash memory, or a CD-ROM, or a storage device such as a hard disk that is built into the computer system.

Further, the “recording medium that can be read by a computer” may also include a medium that holds the program for a certain period of time, such as a volatile memory (a DRAM, for example) within a computer system that is a server or a client when the program is transmitted over a network such as the Internet or a communication line such as a phone line. In addition, the above-described program may be transmitted, from the computer system in which the program is stored in a storage device or the like, to another computer system, via a transmission medium or by transmission waves in the transmission medium. Here, the “transmission medium” that transmits the program refers to a medium having a function to transmit information, such as the Internet or another network (communication network), and a communication line such as a telephone line. Further, the above-described program may be a program for realizing a part of the above-described functions. Moreover, it may be a means to realize the above-described functions in a combination with a program already recorded in the computer system, namely, a so-called differential file (differential program).

Note that various aspects of the embodiments described above may be combined as appropriate. Moreover, some of the component parts may be removed. Moreover, to the extent permissible by law, all publications and US patent documents related to the devices or the like used in the embodiments and modification examples as described above are incorporated herein by reference.

### REFERENCE SIGNS LIST

1 Microscope observation system
10 Analysis device
20 Microscope device
21 Electromotive stage
22 Image capturing unit
30 Display unit
100 Computing unit
101 Living cell extraction unit
102 Cell image specifying unit
103 Cell image acquisition unit
104 Fixed cell extraction unit
105 Feature value calculation unit
106b Correlation extraction unit
107 Creation unit
200 Storage unit
201 Type storage unit
202 Experiment condition storage unit
300 Result output unit
400 Operation detection unit

1. An analysis device configured to analyze a correlation between feature values within a cell in response to a stimulus, the analysis device comprising:
a living cell feature value extraction unit configured to extract a feature value of a living cell from a captured image of the living cell;
a fixed cell feature value extraction unit configured to extract a feature value of a fixed cell from a captured image of a cell that is the fixed cell of the living cell; and
a computing unit configured to associate a feature value of the living cell extracted by the living cell feature value extraction unit with a feature value of the fixed cell extracted by the fixed cell feature value extraction unit.

2. The analysis device according to claim 1, further comprising:
a correlation calculation unit configured to calculate a correlation between feature values within a cell in response to the stimulus from a feature value of the fixed cell and a feature value of the living cell.

3. The analysis device according to claim 2, wherein a correlation between feature values within a cell in response to the stimulus is calculated from a plurality of captured images of cells fixed with different elapsed times in response to the stimulus.

4. The analysis device according to claim 3, wherein a feature value of a living cell is extracted from the living cell corresponding to a cell fixed with the different elapsed time, and a correlation between feature values within a cell in response to the stimulus is calculated.

5. The analysis device according to claim 2, further comprising:
a correlation extraction unit configured to be indicated by the correlation based on biological information of the feature value with respect to a correlation between feature values within a cell calculated by the correlation calculation unit.

6. The analysis device according to claim 1, wherein the feature value of the living cell is a dynamic feature value.

7. The analysis device according to claim 1, further comprising:
a microscope configured to image capture the cell.

8. The analysis device according to claim 1, wherein the living cell feature value extraction unit specifies a feature value of the living cell from a captured image of the living cell after the stimulus is applied.

9. The analysis device according to claim 1, wherein the living cell feature value extraction unit specifies a feature value of the living cell from a captured image of the living cell before the stimulus is applied.

10. The analysis device according to claim 1, wherein a cell corresponding to a living cell extracted by the living cell feature value extraction unit is extracted from a captured image of a cell that is a fixed cell of the living cell.

11. An analysis method performed by an analysis device configured to analyze a correlation between feature values within a cell in response to a stimulus, the analysis method comprising:
extracting a feature value of a living cell from a captured image of the living cell;
extracting a feature value of a fixed cell from a captured image of a cell that is the fixed cell of the living cell; and
computing to associate a feature value of the living cell extracted in the extracting of the feature value of the living cell with a feature value of the fixed cell extracted in the extracting of the feature value of the fixed cell.

12. A program configured to cause a computer of an analysis device to perform:
extracting a feature value of a living cell from a captured image of the living cell;
extracting a feature value of a fixed cell from a captured image of a cell that is the fixed cell of the living cell; and
computing to associate a feature value of the living cell extracted in the extracting of the feature value of the living cell with a feature value of the fixed cell extracted in the extracting of the feature value of the fixed cell.
